(19) United States
(12) Patent Application Publication
(10) Pub. No.: US 2021/0089799 A1
(43) Pub. Date: Mar. 25, 2021

(54) Pedestrian Recognition Method and Apparatus and Storage Medium

(71) Applicant: Shenzhen Sensetime Technology Co., Ltd., Shenzhen (CN)

(72) Inventors: Chengkai Zhu, Shenzhen (CN); Shoukui Zhang, Shenzhen (CN); Wei Wu, Shenzhen (CN); Junjie Yan, Shenzhen (CN); Xiaoying Huang, Shenzhen (CN)

(73) Assignee: Shenzhen Sensetime Technology Co., Ltd., Shenzhen (CN)

(21) Appl. No.: 17/113,949

(22) Filed: Dec. 7, 2020

Related U.S. Application Data
(63) Continuation of application No. PCT/CN2019/125667, filed on Dec. 16, 2019.

(30) Foreign Application Priority Data
Dec. 29, 2018 (CN) 201811637119.4

(51) Int. Cl. G06K 9/00; G06T 7/00; G06K 9/62

(52) U.S. Cl. CPC G06K 9/00892; G06T 7/0002; G06K 9/00281; G06T 2207/30168; G06K 9/622; G06K 9/6215; G06K 9/00771; G06K 9/00348

(57) ABSTRACT

A pedestrian recognition method and device. The method comprises: acquiring image features of a target pedestrian image, the image features comprising facial features and body features (S101); acquiring from a feature database at least one target node of the image features, and using a pedestrian image that corresponds to the at least one target node as an image of a target pedestrian (S103); the feature database comprises multiple pedestrian feature nodes, and the pedestrian feature nodes comprise facial features and body features which correspond to a pedestrian image, as well as relationship features between other pedestrian feature nodes. The described method enables the amount of computation for pedestrian searching to be greatly reduced, which improves searching efficiency.

### CROSS REFERENCE TO RELATED APPLICATIONS

The present disclosure is a continuation of and claims priority under 35 U.S.C. § 120 to PCT Application No. PCT/CN2019/125667, filed on Dec. 16, 2019, which claims priority to Chinese Patent Application No. 201811637119.4, with the title of “Pedestrian Recognition Method and Device”, filed on Dec. 29, 2018 with CNIPA. The entireties of these applications are incorporated herein by reference.

### TECHNICAL FIELD

The present disclosure relates to the technical field of computer vision, in particular to a pedestrian recognition method and device.

### BACKGROUND

The pedestrian recognition technology plays an important role in the security analysis fields such as smart cities, public security, and the like, and is also an important subject in the field of computer vision. The pedestrian recognition is a challenging technology. In related art, the pedestrian recognition technology works generally based on human characteristics such as pedestrians' clothing and character attributes. Typical technologies may include Person Re-identification (Person ReID), for example. However, due to many environmental factors and external factors such as clothing change of pedestrians, the uniqueness of human characteristics is often not high.

### SUMMARY

To overcome the problems existing in the related art, the present disclosure provides a pedestrian recognition method and device.

According to a first aspect of an embodiment of the present disclosure, there is provided a pedestrian recognition method, comprising:

acquiring image features of images of a target pedestrian, wherein the image features include face features and body features; and

acquiring, from a feature database, at least one target node of the image features, and taking pedestrian images respectively corresponding to the at least one target node as images of the target pedestrian;

wherein the feature database comprises a plurality of pedestrian feature nodes, the pedestrian feature nodes comprising face features and body features which correspond to the pedestrian images, as well as features of relationship between the pedestrian feature node and other pedestrian feature nodes.

According to a second aspect of the embodiment of the present disclosure, there is provided a pedestrian recognition device, comprising:

an image feature acquisition module, configured to acquire image features of images of a target pedestrian, wherein the image features include face features and body features;

a target node acquisition module, configured to acquire at least one target node of the image features from a feature database, and take pedestrian images respectively corresponding to the at least one target node as images of the target pedestrian;

wherein the feature database includes a plurality of pedestrian feature nodes, the pedestrian feature nodes including face features and body features corresponding to the pedestrian images and features of relationship between one pedestrian feature node and other pedestrian feature nodes.

According to a third aspect of the embodiment of the present disclosure, there is provided an electronic apparatus, comprising:

a processor;

a memory for storing processor executable instructions;

wherein the processor is configured to execute the above pedestrian recognition method.

According to a fourth aspect of the embodiment of the present disclosure, there is provided a non-transitory computer readable storage medium that, when instructions in the storage medium are executed by a processor, enables the processor to execute the above pedestrian recognition method.

According to a fifth aspect of the embodiment of the present disclosure, there is provided a computer program comprising computer readable code, and when the computer readable code is run in an electronic apparatus, a processor in the electronic apparatus executes the above pedestrian recognition method.

It should be understood that the above general description and the following detailed description only serve an exemplary and explanatory purpose, and are not intended to limit the present disclosure.

### BRIEF DESCRIPTION OF THE DRAWINGS

The drawings below are incorporated into the specification and constitute a part of the specification. The drawings illustrate embodiments in accordance with the present disclosure and together with the specification are used to explain the technical solutions of the present disclosure.

FIG. 1 shows a flowchart of a pedestrian recognition method according to an exemplary embodiment of the present disclosure.

FIG. 2 is a scene diagram according to an exemplary embodiment of the present disclosure.

FIG. 3 shows a block diagram of a device according to an exemplary embodiment of the present disclosure.

FIG. 4 shows a block diagram of an apparatus according to an exemplary embodiment of the present disclosure.

FIG. 5 shows a block diagram of an apparatus according to an exemplary embodiment of the present disclosure.

### DETAILED DESCRIPTION OF THE EMBODIMENTS

Hereinafter, exemplary embodiments will be described in detail, examples of which are presented in the drawings. When the following description refers to the drawings, unless otherwise specified particularly, the same reference numerals in different drawings denote the same or similar elements. The implementations described in the exemplary embodiments below do not represent all implementations consistent with the present disclosure. Rather, they are merely examples of devices and methods consistent with some aspects of the present disclosure as specified in the appended claims.

To facilitate the understanding of those skilled in the art of the technical solutions provided by the embodiments of the present disclosure, the technical environment for realizing the technical solutions will be firstly described below.

The pedestrian recognition technology in the related art is often based on face recognition technology or human body recognition technology, and the pedestrian recognition technology based on face recognition technology often identifies the target pedestrian through the pedestrian's face features. However, in practical application scenarios, such as street scenes, the captured pedestrian face images are often blocked, captured from side angles or from a far distance, etc. Therefore, the method of recognizing target pedestrians by face features generally has low recall rate and accuracy.

Based on the actual technical needs similar to those mentioned above, the pedestrian recognition method provided by the present disclosure can set up a feature database based on face features and body features by a search mode which combines the face features and the body features. Based on the face features and the body features of a target pedestrian, face features and body features similar to those of the target pedestrian can be searched out from the feature database, and pedestrian images corresponding to the similar face features and body features can be taken as images of the target pedestrian.

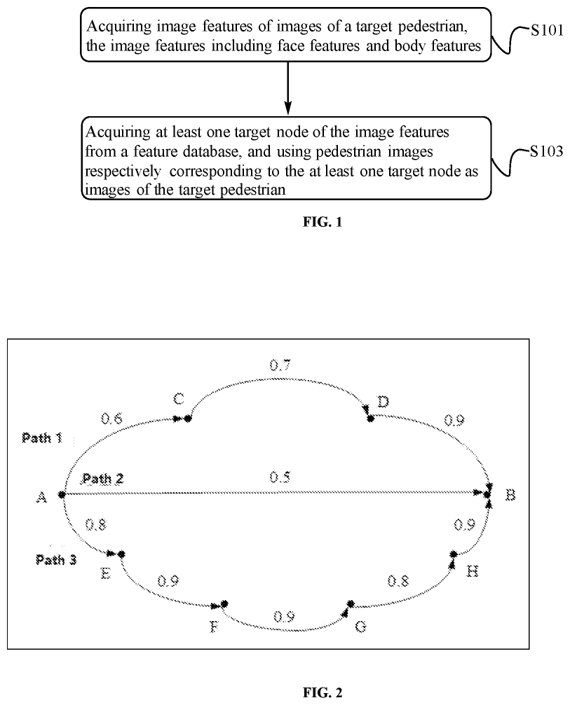

The pedestrian recognition method according to the present disclosure will be described in detail with reference to FIG. 1 which is a method flowchart according to an embodiment of a pedestrian recognition method provided by the present disclosure. Although the present disclosure provides the operation steps of the method as shown in the following embodiments or drawings, more or fewer operation steps may be included in the method based on conventional or non-creative efforts. In steps where there is no necessary causal relationship logically, the execution order of these steps is not limited to the execution order provided by the embodiments of the present disclosure.

An embodiment of the present disclosure provides a pedestrian recognition method, which may be applied in any image processing device. For example, the method may be applied in terminal apparatuses or servers, or other processing apparatuses, wherein the terminal apparatuses may include User Equipment (UE), mobile apparatuses, user terminals, terminals, cellular phones, cordless phones, Personal Digital Assistant (PDA), handheld apparatuses, computing apparatuses, vehicle-mounted apparatuses, wearable apparatuses, etc. In some possible implementations, the pedestrian recognition method may be implemented by invoking the computer readable instructions stored in the memory by a processor.

To be specific, an embodiment of the pedestrian recognition method provided by the present disclosure is shown in FIG. 1. The method may comprise:

S101: acquiring image features of images of a target pedestrian, the image features including face features and body features;

S103: acquiring, from a feature database, at least one target node of the image features, and taking pedestrian images respectively corresponding to the at least one target node as images of the target pedestrian;

wherein the feature database comprises a plurality of pedestrian feature nodes which comprise face features and body features which correspond to the pedestrian images, as well as features of relationship between one pedestrian feature node and other pedestrian feature nodes.

In an embodiment of the present disclosure, images of a target pedestrian used as a search basis can be obtained. For example, if the target pedestrian is Zhang San, the images of the target pedestrian may include, for instance, Zhang San's ID photo, daily-life photos, photos snapped on the street, portraits and so on. Images of the target pedestrian may include face images, body images, or face and body images. On this basis, image features can be obtained from the images of the target pedestrian, which may include face features and body features. That is, when only face images are included in the images of the target pedestrian, face features can be obtained; in other words, the face features in the image features are non-zero values and the body features are zero values; when only body images are included in the images of the target pedestrian, body features can be obtained; in other words, the face features in the image features are zero values and the body features are non-zero values; and when face and body images are included in the images of the target pedestrian, face features and body features can be obtained; in other words, the face features and the body features in the image features are non-zero values. The face features and the body features can be expressed by feature vectors. For example, the face feature vectors may include various components between key points of the face, such as Euclidean distance, curvature, angle, and the body feature vectors may include components such as proportion, posture and clothing characteristics of body parts. The present disclosure does not limit the extraction method of the face features and the body features.

In an embodiment of the present disclosure, after obtaining the image features of the images of the target pedestrian, at least one target node of the image features can be obtained from a preset feature database based on the image features. The feature database may include a plurality of pedestrian feature nodes which include face features and body features that correspond to the pedestrian images, as well as features of relationship between one pedestrian feature node and other pedestrian feature nodes. In one embodiment, the pedestrian feature nodes have a one-to-one corresponding relationship with the pedestrian images. For example, if the feature database may include 1 million pedestrian feature nodes, the 1 million pedestrian feature nodes correspond to 1 million pedestrian images. Then, the object of the embodiment of the present disclosure is to search out the images of the target pedestrian from the 1 million pedestrian images. Similarly, the pedestrian images may include face images, body images, and face and body images. On this basis, the face features and the body features of the pedestrian images can be extracted and set in the pedestrian feature nodes corresponding to the pedestrian images.

In an embodiment of the present disclosure, the features of relationship between one pedestrian feature node and other pedestrian feature nodes can be configured to be determined according to the face features and the body features. The features of relationship include association relationship between similar nodes. The association relationship between similar nodes includes that the similarity between two pedestrian feature nodes is high; that is, the two pedestrian feature nodes are very likely to be the feature nodes of the same pedestrian. According to the association relationship between the similar nodes, one pedestrian feature node can be found by search through another pedestrian feature node. In one embodiment, in the case where the face features of two pedestrian feature nodes are non-zero values and the similarity between the face features of the two pedestrian feature nodes is greater than or equal to a preset face similarity threshold, it is determined that the two pedestrian feature nodes have an association relationship of similar nodes. In another embodiment, in the case where the body features of two pedestrian feature nodes are non-zero values and the similarity between the body features of the two pedestrian feature nodes is greater than or equal to a preset body similarity threshold, it is determined that the two pedestrian feature nodes have an association relationship of similar nodes. In one embodiment of the present disclosure, the similarity between the face features or the body features can be calculated using feature vectors; for example, the similarity can be a cosine value between two feature vectors. The present disclosure does not limit the calculation method of the similarity between two features.

In practical application scenarios, image quality plays an important role in face recognition and body recognition. When the image quality is high, the accuracy of face recognition and body recognition increases, while when the image quality is low, the accuracy of face recognition and body recognition decreases. On this basis, in one embodiment of the present disclosure, the features of relationship are configured to be determined according to the following parameters: face image quality values, body image quality values, face features and body features. The face image quality value can be calculated according to parameters such as face 3D pose, degree of blur of pictures, exposure quality, etc., and the body image quality value can be calculated according to parameters such as blocking degree, congestion degree, subject person integrity, etc. In this case, the pedestrian feature nodes may also include face image quality values and body image quality values. Accordingly, the image features of the images of the target pedestrian may also include face image quality values and body image quality values.

Accordingly, in the process of determining the association relationship of similar nodes, the similarity between the face features of two pedestrian feature nodes can be calculated first. The reason for doing so is the uniqueness and accuracy of the face features. Therefore, the priority of the face features can be set higher than that of the body features. To be specific, in the case where a smaller face image quality value of two pedestrian feature nodes is greater than or equal to a preset face image quality threshold, the similarity between the face features of the two pedestrian feature nodes can be determined. That is to say, when the face features in the two pedestrian feature nodes are all non-zero values and the face image quality values in the two pedestrian feature nodes are both greater than or equal to a preset face image quality threshold, the similarity between the face features of the two pedestrian feature nodes is determined. If the calculated similarity between the face features is greater than or equal to a preset face similarity threshold, it is determined that the two pedestrian feature nodes have an association relationship of similar nodes.

If the smaller face image quality value of the two pedestrian feature nodes is less than the preset face image quality threshold, it can be determined whether the body features of the two pedestrian feature nodes are non-zero values. When it is determined that the body features in the two pedestrian feature nodes are both non-zero values and a smaller body image quality value in the two pedestrian feature nodes is greater than or equal to a preset body image quality threshold, the similarity between the body features of the two pedestrian feature nodes can be calculated. When the similarity between the body features is greater than or equal to a preset body similarity threshold, it can be determined that the two pedestrian feature nodes have an association relationship of similar nodes. It should be noted that the preset face image quality threshold, the preset body image quality threshold, the preset face similarity threshold and the preset body similarity threshold can be set with reference to empirical values, or can be obtained according to sample data statistics, which is not limited by the present disclosure.

After determining, among the plurality of pedestrian feature nodes, the pedestrian feature nodes with an association relationship of similar nodes, a relational graph in a network form can be formed among the plurality of pedestrian feature nodes. Through one of the pedestrian feature nodes, pedestrian feature nodes which have an association relationship of similar nodes with it can be searched out from the feature database. The expression of the feature database may include network structures such as heterogeneous figures.

In an embodiment of the present disclosure, in the process of acquiring at least one target node of the image features from the feature database and taking pedestrian images respectively corresponding to the at least one target node as images of the target pedestrian, the image features can be taken as target feature nodes, and at least one search path from the target feature nodes to the pedestrian feature nodes can be determined, and the search path is formed by connecting a plurality of pedestrian feature nodes which have an association relationship of similar nodes. After the at least one search path is determined, a minimum value of the similarity between two adjacent pedestrian feature nodes in the search path can be determined, and the minimum value is taken as a path score of the search path. After path scores of the respective search paths are determined, a maximum value of the path score of the at least one search path can be determined, and taken as the similarity between the target feature nodes and the pedestrian feature nodes. Finally, at least one pedestrian feature node, the similarity between which and the target feature nodes is greater than or equal to the preset face similarity threshold or the preset body similarity threshold, is taken as at least one target node of the target feature nodes, and pedestrian images respectively corresponding to the at least one target node are taken as images of the target pedestrian.

The method according to the above embodiment will be explained with reference to FIG. 2. As shown in FIG. 2, the target feature node is set as a node A, and nodes B-H are pedestrian feature nodes in the feature database. There are three paths from the node A to the node B, namely, path 1, path 2 and path 3, wherein the node C and the node D, and the node D and the node B in path 1 have an association relationship of similar nodes, respectively, while the node E and the node F, the node F and the node G, the node G and the node H, and the node H and the node B in path 3 have an association relationship of similar nodes, respectively. According to the indication in path 2, a direct similarity between the node A and the node B is 0.5. If the preset face similarity threshold and preset body similarity threshold are 0.7, it will not be determined that the node B is a similar node of the node A. Based on the actual application scenario, both the node A and the node B are the features of the target pedestrian, but the node A may correspond to a front image of the target pedestrian dressed in black, while the node B may correspond to a side image of the target pedestrian dressed in yellow, so a direct similarity between the node A and the node B may be relatively low. However, when the node B is reached through other associated nodes, it can be found that the node A and the node B are closely related. For example, in path 1, the node C is a front image of the face of the target pedestrian, and the node D is a front image of the target pedestrian dressed in that yellow. On this basis, the calculation method of similarity between the node A and the node B can be optimized. In one embodiment, path scores of the paths can be calculated, respectively, and the path scores may include a minimum value of the similarity between two adjacent pedestrian feature nodes in the paths. For example, if the path score of path 1 is 0.6, the path score of path 2 is 0.5, and the path score of path 3 is 0.8 which is the greatest path score among the three paths, then the similarity between the node A and the node B can be determined to be 0.8, which is greater than 0.7. Therefore, the node A and the node B are the target nodes of the target feature node A.

Based on the above, the feature database can be searched using the same method as described in the above embodiment to search out at least one target node of the target feature nodes, and take pedestrian images respectively corresponding to the at least one target node as images of the target pedestrian.

In one embodiment of the present disclosure, in the process of acquiring at least one target node of the image features from a feature database and taking pedestrian images respectively corresponding to the at least one target node as images of the target pedestrian, after searching at least one similar node of the image features from the feature database based on features of relationship between the plurality of pedestrian feature nodes, similar nodes of which the face features deviate too much from the face clustering central value are filtered out from the at least one similar node, and the remaining similar nodes are taken as target nodes. The way of obtaining the similar nodes can refer to the way of searching for the target node B of the node A in the above example. The specific filtering method can determine the face clustering central value of the face features in the at least one similar node. Then, at least one face and body feature node is selected from the at least one similar node, and the face features and the body features in the face and body feature node are non-zero values. Next, nodes of which the face features deviate too much from the face clustering central value can be filtered out from the at least one face and body feature node. To be specific, face similarity between the face features in the at least one face and body feature node and the face clustering central value can be calculated respectively, and nodes with the face similarity greater than or equal to a preset similarity threshold are divided into a first set of similar nodes, and nodes with the face similarity smaller than the preset similarity threshold are divided into a second set of similar nodes. The similar nodes in the second set of similar nodes are very likely not the nodes corresponding to the target pedestrian. Therefore, the second set of similar nodes can be removed from the at least one similar node, and the pedestrian images respectively corresponding to the at least one similar node after the removal are taken as images of the target pedestrian.

In one embodiment of the present disclosure, the at least one similar node may be further filtered to remove nodes of which body features deviate from a body clustering central value in similar nodes with zero-valued face features and non-zero-valued body features. To be specific, in one embodiment, a first body clustering central value of body features in the first set of similar nodes and a second body clustering central value of body features in the second set of similar nodes can be calculated. Then, at least one body feature node can be selected from the at least one similar node, wherein the face features in the body feature node are zero values while the body features are non-zero values. A first body similarity between the body features in the at least one body feature node and the first body clustering central value, and a second body similarity between the body features in the at least one body feature node and the second body clustering central value are calculated, respectively. Because the face features in the second set of similar nodes deviate too much from the clustering central value of the face features, the second set of similar nodes is the nodes configured to be filtered out. If the second body similarity is greater than the first body similarity, it means that the body features also deviate from the body features of the target pedestrian. Therefore, when the second body similarity is greater than the first body similarity, the corresponding body feature nodes can be added to the second set of similar nodes. Then, the second set of similar nodes can be removed from the at least one similar node.

It should be noted that in practical application scenarios, a plurality of images of target pedestrian are often used for feature search. In this process, feature search can be performed on the plurality of images of target pedestrian respectively, and at least one target node is obtained respectively. Finally, the at least one target node obtained respectively can be combined, and pedestrian images corresponding to the combined at least one target node are taken as images of the target pedestrian.

In one embodiment of the present disclosure, after obtaining images of the target pedestrian, the action track of the target pedestrian can be obtained based on the images of the target pedestrian, and the action track includes time information and/or position information. In one example, the action track of the target pedestrian includes, for example, 10:30 on Oct. 1, 2018: Guanqian Street, Suzhou→11:03 on Oct. 1, 2018: Guanqian Street, Suzhou→12:50 on Oct. 1, 2018: XX parking lot, Suzhou→ . . . →21:37 on Oct. 1, 2018: XX community, Suzhou. Based on the above action track, the daily activities of the target pedestrian can be obtained, which has important value in the fields of public security and psychological analysis.

Of course, in order to make the feature database contain as much data as possible, the feature database can be updated. In one example, after the captured video of a street is acquired, image frames in the captured video can be extracted. Then, feature extraction can be performed on the image frames to extract image features of the image frames, the image features including face features and body features. Then, the image features in the image frames are used as new pedestrian feature nodes and updated to the feature database.

According to the pedestrian recognition methods provided by various embodiments of the present disclosure, images of a target pedestrian can be searched out from a feature database by a search mode which combines face features and body features. On one hand, said search mode combining face features and body features can not only utilize the uniqueness advantage of the face features, but also utilize the recognition advantage of the body features under special circumstances such as blocked face or blurred face. On the other hand, the feature database may include features of relationship between one pedestrian feature node and other pedestrian feature nodes, such that through one pedestrian feature node, pedestrian feature nodes associated with it can be found by search. On this basis, the calculation amount of search for pedestrians can be greatly reduced and the search efficiency can be improved.

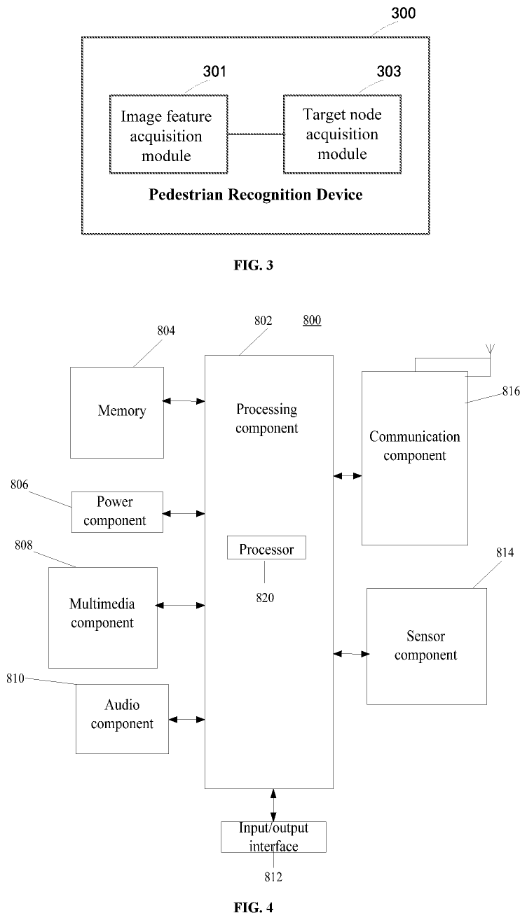

Another aspect of the embodiments of the present disclosure further provides a pedestrian recognition device. FIG. 3 shows a block diagram of a pedestrian recognition device according to an embodiment of the present disclosure. As shown in FIG. 3, the device 300 comprises:

an image feature acquisition module 301, configured to acquire image features of images of a target pedestrian, wherein the image features include face features and body features; and

a target node acquisition module 303, configured to acquire at least one target node of the image features from a feature database, and take pedestrian images respectively corresponding to the at least one target node as images of the target pedestrian;

wherein the feature database includes a plurality of pedestrian feature nodes, the pedestrian feature nodes including face features and body features corresponding to the pedestrian images and features of relationship between one pedestrian feature node and other pedestrian feature nodes.

Optionally, in one embodiment of the present disclosure, the features of relationship are configured to be determined according to the following parameters: face image quality values, body image quality values, face features and body features.

Optionally, in one embodiment of the present disclosure, the features of relationship include association relationship between similar nodes, which is configured to be determined in the way below:

determining a similarity between the face features of two pedestrian feature nodes, in the case where a smaller face image quality value of the two pedestrian feature nodes is greater than or equal to a preset face image quality threshold;

determining that the two pedestrian feature nodes have an association relationship of similar nodes, in the case where the similarity between the face features is greater than or equal to a preset face similarity threshold;

determining the similarity between the body features of the two pedestrian feature nodes, in the case where the smaller face image quality value of the two pedestrian feature nodes is less than a preset face image quality threshold and a smaller body image quality value of the two pedestrian feature nodes is greater than or equal to a body image quality threshold; and

determining that the two pedestrian feature nodes have an association relationship of similar nodes, in the case where the similarity between the body features is greater than or equal to a preset body similarity threshold.

Optionally, in one embodiment of the present disclosure, the target node acquisition module comprises:

a path determination submodule, configured to take the image features as target feature nodes and determine at least one search path from the target feature nodes to the pedestrian feature nodes, wherein the search path is formed by connecting a plurality of pedestrian feature nodes with an association relationship of similar nodes;

a path score determination submodule, configured to determine a minimum value of the similarity between two adjacent pedestrian feature nodes in the search path, and take the minimum value as a path score of the search path;

a node similarity determination submodule, configured to determine a maximum value of the path score of the at least one search path, and take the maximum value as the similarity between the target feature nodes and the pedestrian feature nodes; and

a target node determination submodule, configured to take at least one pedestrian feature node, the similarity between which and the target feature nodes is greater than or equal to the preset face similarity threshold or the preset body similarity threshold, as at least one target node of the target feature nodes, and take pedestrian images respectively corresponding to the at least one target node as images of the target pedestrian.

Optionally, in one embodiment of the present disclosure, the target node acquisition module comprises:

a similar node searching submodule, configured to search out at least one similar node of the image features from the feature database based on features of relationship between the plurality of pedestrian feature nodes;

a target node selecting submodule, configured to select at least one target node from the at least one similar node; and

a pedestrian image acquisition submodule, configured to take pedestrian images respectively corresponding to the at least one target node as images of the target pedestrian.

Optionally, in one embodiment of the present disclosure, the target node selecting submodule comprises:

a face central value determination unit, configured to determine a face clustering central value of face features in the at least one similar node;

a node screening unit, configured to select at least one face and body feature node from the at least one similar node, wherein the face features and the body features in the face and body feature node are non-zero values;

a node dividing unit, configured to determine a face similarity between the face features in the at least one face and body feature node and the face clustering central value, respectively, divide the nodes with the face similarity greater than or equal to a preset similarity threshold into a first set of similar nodes, and divide the nodes with the face similarity less than the preset similarity threshold into a second set of similar nodes; and

a node removal unit, configured to remove the second set of similar nodes from the at least one similar node, and take pedestrian images respectively corresponding to the at least one similar node after the removal as images of the target pedestrian.

Optionally, in one embodiment of the present disclosure, the target node selecting submodule further comprises:

a body central value determination unit, configured to determine a first body clustering central value of the body features in the first set of similar nodes and a second body clustering central value of the body features in the second set of similar nodes;

a body node screening unit, configured to select at least one body feature node from the at least one similar node, wherein the face features in the body feature node are zero values and the body features are non-zero values;

a similarity determination unit, configured to determine a first body similarity between the body features in the at least one body feature node and the first body clustering central value and a second body similarity between the body features in the at least one body feature node and the second body clustering central value, respectively; and

a node adding unit, configured to, when the second body similarity is greater than the first body similarity, add corresponding body feature nodes to the second set of similar nodes.

Optionally, in one embodiment of the present disclosure, the device further comprises:

a pedestrian track acquisition module, configured to acquire an action track of the target pedestrian based on images of the target pedestrian, wherein the action track includes time information and/or position information.

Optionally, in one embodiment of the present disclosure, the device further comprises:

a new data acquisition module, configured to, under the condition of acquiring a new pedestrian image, extract image features of the new pedestrian image; and

a data updating module, configured to update the image features of the new pedestrian image as new pedestrian feature nodes into the feature database.

An embodiment of the disclosure provides an electronic apparatus, which comprises a processor; a memory for storing processor executable instructions; wherein the processor is configured to execute the method described in the above embodiments.

The electronic apparatus can be provided as a terminal, a server or other forms of apparatus.

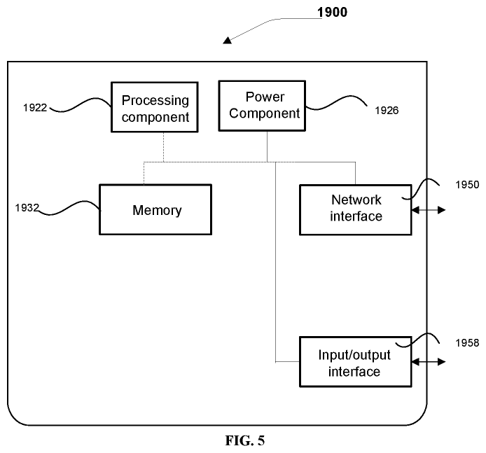

FIG. 4 shows a block diagram of an electronic apparatus 800 according to an embodiment of the present disclosure. For example, the electronic apparatus 800 can be a mobile phone, a computer, a digital broadcasting terminal, a messaging apparatus, a game console, a tablet apparatus, a medical apparatus, a fitness apparatus, a personal digital assistant and the like.

Referring to FIG. 4, the electronic apparatus 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the electronic apparatus 800, such as operations associated with display, telephone call, data communication, camera operation and recording operation. The processing component 802 may include one or more processors 820 to execute instructions to complete all or part of the steps of the method described above. In addition, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store various types of data to support operations at the electronic apparatus 800. Examples of such data include instruction of any application program or method operated on the electronic apparatus 800, contact data, phone book data, messages, pictures, videos, and the like. The memory 804 may be implemented by any type of volatile or non-volatile storage devices or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the electronic apparatus 800. The power component 806 may include a power management system, one or more power sources, and other components associated with generating, managing, and distributing power for the electronic apparatus 800.

The multimedia component 808 includes a screen that provides an output interface between the electronic apparatus 800 and a user. In some embodiments, the screen may include a liquid crystal display (LCD) and a touch panel (TP). If the screen includes a touch panel, the screen may be implemented as a touch screen to receive an input signal from the user. The touch panel includes one or more touch sensors to sense touch, sliding, and gestures on the touch panel. The touch sensor may not only sense the boundary of a touch or a sliding action, but also detect the duration time and pressure related to the touch or the sliding operation. In some embodiments, the multimedia component 808 includes a front camera and/or a rear camera. When the electronic apparatus 800 is in an operation mode, such as a shooting mode or a video mode, the front camera and/or the rear camera can receive external multimedia data. Each front camera and rear camera may be a fixed optical lens system or have focal length and optical zoom capability.

The audio component 810 is configured to output and/or input audio signals. For example, the audio component 810 includes a microphone (MIC) configured to receive external audio signals when the electronic apparatus 800 is in an operation mode, such as a call mode, a recording mode and a voice recognition mode. The received audio signals may be further stored in the memory 804 or transmitted via the communication component 816. In some embodiments, the audio component 810 further includes a speaker for outputting audio signals.

The I/O interface 812 provides an interface between the processing component 802 and a peripheral interface module which may be keyboard, click wheel, button, etc. The button may include but is not limited to a home button, a volume button, a start button, and a lock button.

The sensor component 814 includes one or more sensors for providing status assessment of various aspects of the electronic apparatus 800. For example, the sensor component 814 can detect the on/off state of the electronic apparatus 800, the relative positioning of the components which are for example a display and a keypad of the electronic apparatus 800. The sensor component 814 may also detect the position change of the electronic apparatus 800 or a component of the electronic apparatus 800, the presence or absence of contact between the user and the electronic apparatus 800, the orientation or acceleration/deceleration of the electronic apparatus 800 and the temperature change of the electronic apparatus 800. The sensor component 814 may include a proximity sensor configured to detect the presence of nearby objects without any physical contact. The sensor component 814 may also include an optical sensor, such as a CMOS or CCD image sensor, for use in imaging applications. In some embodiments, the sensor component 814 may also include an acceleration sensor, a gyro sensor, a magnetic sensor, a pressure sensor or a temperature sensor.

The communication component 816 is configured to facilitate wired or wireless communication between electronic apparatus 800 and other apparatuses. The electronic apparatus 800 can access a wireless network based on a communication standard, such as WiFi, 2G or 3G, or a combination thereof In one exemplary embodiment, the communication component 816 receives a broadcast signal from an external broadcast management system or broadcasts related information via a broadcast channel. In one exemplary embodiment, the communication component 816 further includes a near field communication (NFC) module to facilitate short-range communication. For example, the NFC module can be implemented based on Radio Frequency Identification (RFID) technology, Infrared Data Association (IrDA) technology, Ultra Wideband (UWB) technology, Bluetooth (BT) technology and other technologies.

In an exemplary embodiment, the electronic apparatus 800 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic components, for performing the above methods.

In an exemplary embodiment, a non-volatile computer readable storage medium, such as the memory 804 including computer program instructions, is also provided. The computer program instructions can be executed by the processor 820 of the electronic apparatus 800 to complete the above methods.

FIG. 5 shows a block diagram of an electronic apparatus 1900 according to an exemplary embodiment of the present disclosure. For example, the electronic apparatus 1900 can be provided as a server. Referring to FIG. 5, the electronic apparatus 1900 includes a processing component 1922 which further includes one or more processors, and memory resources represented by a memory 1932 for storing instructions, such as application programs, that can be executed by the processing component 1922. The application programs stored in the memory 1932 may include one or more modules each corresponding to a set of instructions. In addition, the processing component 1922 is configured to execute instructions to execute the above methods.

The electronic apparatus 1900 may further include a power component 1926 configured to perform power management of the electronic apparatus 1900, a wired or wireless network interface 1950 configured to connect the electronic apparatus 1900 to a network, and an input/output (I/O) interface 1958. The electronic apparatus 1900 may operate an operating system stored in the memory 1932, such as Windows Server™, Mac OS X™, Unix™, Linux™, FreeBSD™ or the like.

In an exemplary embodiment, a non-volatile computer readable storage medium, such as the memory 1932 including computer program instructions, is also provided. The computer program instructions can be executed by the processing component 1922 of the electronic apparatus 1900 to complete the above methods.

The present disclosure may be a system, a method, and/or a computer program product. The computer program product may include a computer readable storage medium having computer readable program instructions for causing a processor to implement the aspects of the present disclosure stored thereon.

The computer readable storage medium may be a tangible apparatus that can retain and store instructions used by an instruction executing apparatus. The computer readable storage medium may be, but not limited to, e.g., electronic storage apparatus, magnetic storage apparatus, optical storage apparatus, electromagnetic storage apparatus, semiconductor storage apparatus, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded apparatus (for example, punch-cards or raised structures in a groove having instructions stored thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to respective computing/processing apparatuses from a computer readable storage medium, or to an external computer or external storage device via network, for example, the Internet, local area network, wide area network and/or wireless network. The network may comprise copper transmission cables, optical fibers transmission, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium in the respective computing/processing apparatuses.

Computer readable program instructions for executing the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” language or similar programming languages. The computer readable program instructions may be executed completely on the user's computer, partly on the user's computer, as a stand-alone software package, partly on the user's computer and partly on a remote computer, or completely on a remote computer or a server. In the scenario relating to remote computer, the remote computer may connect to the user's computer through any type of network, including local area network (LAN) or wide area network (WAN), or connect to an external computer (for example, through the Internet connection by using an Internet Service Provider). In some embodiments, electronic circuitry, such as programmable logic circuitry, field-programmable gate arrays (FPGA), or programmable logic arrays (PLA), may be customized by using state information of the computer readable program instructions, and the electronic circuitry may execute the computer readable program instructions, so as to achieve the aspects of the present disclosure.

Aspects of the present disclosure have been described herein with reference to the flowcharts and/or the block diagrams of the methods, devices (systems), and computer program products according to the embodiments of the present disclosure. It will be appreciated that each block in the flowcharts and/or the block diagrams, and combinations of blocks in the flowcharts and/or block diagrams, can be implemented by the computer readable program instructions.

These computer readable program instructions may be provided to a processor of a general purpose computer, a dedicated computer, or other programmable data processing devices, to produce a machine, such that the instructions create devices for implementing the functions/acts specified in one or more blocks in the flowcharts and/or block diagrams when executed by the processor of the computer or other programmable data processing devices. These computer readable program instructions may also be stored in a computer readable storage medium, wherein the instructions cause a computer, a programmable data processing device and/or other apparatuses to function in a particular manner, such that the computer readable storage medium having instructions stored therein comprises a product that includes instructions implementing aspects of the functions/acts specified in one or more blocks in the flowcharts and/or block diagrams.

The computer readable program instructions may also be loaded onto a computer, other programmable data processing devices, or other apparatuses to have a series of operational steps executed on the computer, other programmable devices or other apparatuses, so as to produce a computer implemented process, such that the instructions executed on the computer, other programmable devices or other apparatuses implement the functions/acts specified in one or more blocks in the flowcharts and/or block diagrams.

The flowcharts and block diagrams in the drawings illustrate the architecture, function, and operation that may be implemented by the systems, methods and computer program products according to a plurality of embodiments of the present disclosure. In this regard, each block in the flowcharts or block diagrams may represent a part of a module, a program segment, or instructions, wherein the part of a module, a program segment, or instructions comprises one or more executable instructions for implementing a specified logical function. In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagrams and/or flowcharts, and combinations of blocks in the block diagrams and/or flowcharts, can be implemented by dedicated hardware-based systems executing the specified functions or acts, or by combinations of dedicated hardware and computer instructions.

Although the embodiments of the present disclosure have been described above, it will be appreciated that the above descriptions are merely exemplary, but not exhaustive; and that the disclosed embodiments are not limiting. A number of variations and modifications may occur apparently to one skilled in the art without departing from the scopes and spirits of the described embodiments. The terms in the present disclosure are selected to provide the best explanation on the spirits and practical applications of the embodiments and the technical improvements to the arts on market, or to make the embodiments described herein understandable to one skilled in the art.

What is claimed is:

1. A pedestrian recognition method, wherein the method comprises:
acquiring image features of images of a target pedestrian, the image features including face features and body features; and
acquiring, from a feature database, at least one target node of the image features, and taking pedestrian images respectively corresponding to the at least one target node as images of the target pedestrian;
wherein the feature database comprises a plurality of pedestrian feature nodes, the pedestrian feature nodes comprising face features and body features which correspond to the pedestrian images, as well as features of relationship between one pedestrian feature node and other pedestrian feature nodes.

2. The pedestrian recognition method according to claim 1, wherein the features of relationship are configured to be determined according to following parameters: face image quality values, body image quality values, face features and body features.

3. The pedestrian recognition method according to claim 2, wherein the features of relationship comprise association relationship between similar nodes, which is configured to be determined in the way below:
determining a similarity between face features of two pedestrian feature nodes, in the case where a smaller face image quality value of the two pedestrian feature nodes is greater than or equal to a preset face image quality threshold;
determining that the two pedestrian feature nodes have the association relationship of similar nodes, in the case where the similarity between the face features is greater than or equal to a preset face similarity threshold;
determining a similarity between body features of the two pedestrian feature nodes, in the case where the smaller face image quality value of the two pedestrian feature nodes is less than the preset face image quality threshold and a smaller body image quality value of the two pedestrian feature nodes is greater than or equal to a body image quality threshold; and
determining that the two pedestrian feature nodes have the association relationship of similar nodes, in the case where the similarity between the body features is greater than or equal to a preset body similarity threshold.

4. The pedestrian recognition method according to claim 3, wherein acquiring, from the feature database, the at least one target node of the image features, and taking pedestrian images that respectively correspond to the at least one target node as the images of the target pedestrian comprises:
taking the image features as target feature nodes, and determining at least one search path from the target feature nodes to the pedestrian feature nodes, the search path being formed by connecting a plurality of pedestrian feature nodes with the association relationship of similar nodes;
determining a minimum value of a similarity between two adjacent pedestrian feature nodes in the search path, and taking the minimum value as a path score of the search path;
determining a maximum value of the path score of the at least one search path, and taking the maximum value as a similarity between the target feature nodes and the pedestrian feature nodes; and
taking at least one pedestrian feature node, the similarity between which and the target feature nodes is greater than or equal to the preset face similarity threshold or the preset body similarity threshold, as the at least one target node of the target feature nodes, and taking pedestrian images respectively corresponding to the at least one target node as the images of the target pedestrian.

5. The pedestrian recognition method according to claim 1, wherein acquiring, from a feature database, the at least one target node of the image features, and taking pedestrian images respectively corresponding to the at least one target node as the images of the target pedestrian comprises:
searching out at least one similar node of the image features from the feature database based on the features of relationship between the plurality of pedestrian feature nodes;
selecting at least one target node from the at least one similar node; and
taking pedestrian images respectively corresponding to the at least one target node as the images of the target pedestrian.

6. The pedestrian recognition method according to claim 5, wherein selecting at least one target node from the at least one similar node comprises:
determining a face clustering central value of face features in the at least one similar node;
selecting at least one face and body feature node from the at least one similar node, face features and body features in the face and body feature node being non-zero values;
determining a face similarity between face features in the at least one face and body feature node and the face clustering central value, respectively, dividing nodes with the face similarity greater than or equal to a preset similarity threshold into a first set of similar nodes, and dividing nodes with the face similarity smaller than the preset similarity threshold into a second set of similar nodes; and
removing the second set of similar nodes from the at least one similar node, and taking pedestrian images respectively corresponding to the at least one similar node after the removal as the images of the target pedestrian.

7. The pedestrian recognition method according to claim 6, wherein before removing the second set of similar nodes from the at least one similar node, the method further comprises:
determining a first body clustering central value of body features in the first set of similar nodes and a second body clustering central value of body features in the second set of similar nodes;
selecting at least one body feature node from the at least one similar node, face features in the body feature nodes being zero values and body features in the body feature nodes being non-zero values;
determining a first body similarity between body features in the at least one body feature node and the first body clustering central value, and a second body similarity between body features in the at least one body feature node and the second body clustering central value, respectively; and
when the second body similarity is greater than the first body similarity, adding the corresponding body feature nodes to the second set of similar nodes.

8. The pedestrian recognition method according to claim 1, wherein the method further comprises:
acquiring an action track of the target pedestrian based on the images of the target pedestrian, the action track including time information and/or position information.

9. The pedestrian recognition method according to claim 1, wherein the method further comprises:
under the condition of acquiring a new pedestrian image, extracting image features of the new pedestrian image; and
updating the image features of the new pedestrian image as new pedestrian feature nodes to the feature database.

10. A pedestrian recognition apparatus, wherein the apparatus comprises:
a processor; and
a memory configured to store processor executable instructions,
wherein the processor is configured to invoke the instructions stored in the memory, so as to:
acquire image features of images of a target pedestrian, the image features comprising face features and body features; and
acquire at least one target node of the image features from a feature database, and take pedestrian images respectively corresponding to the at least one target node as images of the target pedestrian;
wherein the feature database includes a plurality of pedestrian feature nodes, the pedestrian feature nodes including face features and body features corresponding to the pedestrian images and features of relationship between one pedestrian feature node and other pedestrian feature nodes.

11. The pedestrian recognition apparatus according to claim 10, wherein the features of relationship are configured to be determined according to following parameters: face image quality values, body image quality values, face features and body features.

12. The pedestrian recognition apparatus according to claim 11, wherein the features of relationship include association relationship between similar nodes, which is configured to be determined in the way below:
determining a similarity between face features of two pedestrian feature nodes, in the case where a smaller face image quality value of the two pedestrian feature nodes is greater than or equal to a preset face image quality threshold;
determining that the two pedestrian feature nodes have the association relationship of similar nodes, in the case where the similarity between the face features is greater than or equal to a preset face similarity threshold;
determining a similarity between body features of the two pedestrian feature nodes, in the case where the smaller face image quality value of the two pedestrian feature nodes is less than the preset face image quality threshold and a smaller body image quality value of the two pedestrian feature nodes is greater than or equal to a body image quality threshold; and
determining that the two pedestrian feature nodes have the association relationship of similar nodes, in the case where the similarity between the body features is greater than or equal to a preset body similarity threshold.

13. The pedestrian recognition apparatus according to claim 12, wherein acquiring at least one target node of the image features from a feature database, and taking pedestrian images respectively corresponding to the at least one target node as images of the target pedestrian comprises:
taking the image features as target feature nodes and determining at least one search path from the target feature nodes to the pedestrian feature nodes, the search path being formed by connecting a plurality of pedestrian feature nodes with the association relationship of similar nodes;
determining a minimum value of a similarity between two adjacent pedestrian feature nodes in the search path, and taking the minimum value as a path score of the search path;
determining a maximum value of the path score of the at least one search path, and taking the maximum value as a similarity between the target feature nodes and the pedestrian feature nodes; and
taking at least one pedestrian feature node, the similarity between which and the target feature nodes is greater than or equal to the preset face similarity threshold or the preset body similarity threshold, as the at least one target node of the target feature nodes, and taking pedestrian images respectively corresponding to the at least one target node as the images of the target pedestrian.

14. The pedestrian recognition apparatus according to claim 10, wherein acquiring at least one target node of the image features from a feature database, and taking pedestrian images respectively corresponding to the at least one target node as images of the target pedestrian comprises:
searching out at least one similar node of the image features from the feature database based on the features of relationship between the plurality of pedestrian feature nodes;
selecting at least one target node from the at least one similar node; and
taking pedestrian images respectively corresponding to the at least one target node as the images of the target pedestrian.

15. The pedestrian recognition apparatus according to claim 14, wherein selecting at least one target node from the at least one similar node comprises:
determining a face clustering central value of face features in the at least one similar node;
selecting at least one face and body feature node from the at least one similar node, face features and body features in the face and body feature node being non-zero values;
determining a face similarity between face features in the at least one face and body feature node and the face clustering central value, respectively, dividing nodes with the face similarity greater than or equal to a preset similarity threshold into a first set of similar nodes, and dividing nodes with the face similarity less than the preset similarity threshold into a second set of similar nodes; and
removing the second set of similar nodes from the at least one similar node, and taking pedestrian images respectively corresponding to the at least one similar node after the removal as the images of the target pedestrian.

16. The pedestrian recognition apparatus according to claim 15, wherein selecting at least one target node from the at least one similar node further comprises:
determining a first body clustering central value of body features in the first set of similar nodes and a second body clustering central value of body features in the second set of similar nodes;
selecting at least one body feature node from the at least one similar node, face features in the body feature node being zero values and body features being non-zero values;
determining a first body similarity between body features in the at least one body feature node and the first body clustering central value and a second body similarity between body features in the at least one body feature node and the second body clustering central value, respectively; and
when the second body similarity is greater than the first body similarity, adding corresponding body feature nodes to the second set of similar nodes.

17. The pedestrian recognition apparatus according to claim 10, wherein the processor is further configured to:
acquire an action track of the target pedestrian based on the images of the target pedestrian, the action track including time information and/or position information.

18. The pedestrian recognition apparatus according to claim 10, wherein the processor is further configured to:
under the condition of acquiring a new pedestrian image, extract image features of the new pedestrian image; and
update image features of the new pedestrian image as new pedestrian feature nodes into the feature database.

19. A non-transitory computer readable storage medium, having computer program instructions stored thereon, when the computer program instructions are executed by a processor, the processor is caused to perform the operations of:
acquiring image features of images of a target pedestrian, the image features including face features and body features; and
acquiring, from a feature database, at least one target node of the image features, and taking pedestrian images respectively corresponding to the at least one target node as images of the target pedestrian;
wherein the feature database comprises a plurality of pedestrian feature nodes, the pedestrian feature node comprising face features and body features which correspond to the pedestrian images, as well as features of relationship between one pedestrian feature node and other pedestrian feature nodes.
